(19) United States
(12) Patent Application Publication
(10) Pub. No.: US 2016/0148240 A1
(43) Pub. Date: May 26, 2016

(54) System and Method that Rewards Vendors for Offering Nonpublished Coupons

(71) Applicant: ANTONIO COLETTA, Doral, FL (US)

(72) Inventor: ANTONIO COLETTA, Doral, FL (US)

(21) Appl. No.: 14/554,284

(22) Filed: Nov. 26, 2014

(51) Int. Cl. G06Q 30/02

(52) U.S. Cl. CPC G06Q 30/0222; G06Q 30/0213

(57) ABSTRACT

A system and method that rewards vendors for offering nonpublished coupons. The vendor can market and distribute a unique coupon through a gateway for substantially free and is subsequently rewarded when a consumer performs a transaction involving the unique coupon. The unique coupon must be unique, in that it offers exclusivity to the vendor and a time limitation for use of the coupon. Also, the coupon is sold to a consumer for a predetermined coupon fee, rather than given to the consumer gratuitously. To access the coupon, the consumer either searches for the coupon on the internet, or receives a text alert upon approaching a predetermined range of the vendor. The consumer purchases the coupon for a coupon fee, and utilizes the coupon in a transaction with the vendor identified on the coupon. After the coupon has been used, the vendor receives part of the coupon fee.

### BACKGROUND

Typically, in marketing, a coupon is a ticket or document that can be exchanged for a financial discount or rebate when purchasing a product. Customarily, coupons are issued by vendors and manufacturers of consumer packaged goods, to be used in retail stores as a part of sale promotions. Coupons are often widely distributed through mail, coupon envelopes, magazines, newspapers, the Internet (social media, email newsletter), directly from the retailer, and mobile devices such as cell phones. Thus, coupons, enable vendors to offer a lower price only to those consumers who would otherwise go elsewhere. In addition, coupons can also be targeted selectively to regional markets in which price competition is great.

The inventor realized, through past experiences that to promote sales of products or services, the coupon could be a useful marketing tool. The information written on the coupon could be presented in a manner such that the information may be verified to prove that the coupon may be approved by a seller or a coupon issuer. Thus, when a consumer provides the coupon to a vender; in response, the vendor may provide a service or a discount to the customer.

The inventor was also aware that a coupon book typically includes a collection of such paper coupons from multiple vendors selling a variety of products and services. Respective coupons issued by one or more vendors are collected in the coupon book, such that the customer can select one or more coupons from the collected set.

After distributing coupons in this traditional method, the inventor quickly realized that his coupons were diluted by the presence of multiple other coupons, all vying for the attention of the same consumers. This was because, in general, the vendors were continually challenged to attract customers to their products and services in increasingly competitive markets by providing various rewards programs.

The inventor realized that there would be a benefit by distinguishing his coupons from the competitors. The inventor decided to create unique coupons that could only be used through specific vendors and for specific products and services. The inventor started designing the coupons, such that they were unique to the vendor's products and services, and could only be used in the inventor's business venue. The inventor also realized that by not publishing the coupons in traditional means, the coupons would have a larger sense of exclusivity.

Next, the inventor knew that coupons, in general, are distributed with certain conditions, such as a discount rate, a validity term, and the like. In many instances, the consumer could purchase goods at a discounted price or obtain gifts by using the coupons. However, other than the initial conditions, there was very little incentive for the consumer to use the coupon with a specific vendor or in a specific time period. So the inventor included time limitations on the coupons. This created a sense of urgency by the consumer to perform the transaction with the coupon.

However, it was soon apparent to the inventor that the cost of distributing the coupons was prohibitive. Mail outs, internet presence, and radio broadcasts were costing the inventor more than his marketing budget allowed for. The inventor decided to form a gateway, such as a separate internet site that would receive the coupons for free from vendors and then promote them to consumers. The consumer could either search the internet to receive the coupons, or be alerted by a text message when in proximity to the vendor. The gateway freed up the vendors to concentrate on other aspects of the business since the marketing costs were significantly reduced.

However, the inventor realized that the gateway needed to make a profit for distributing the coupons. The inventor enabled the gateway to charge a coupon fee to the consumer. And to provide the vendors with additional profits, the inventor allowed for the vendor to receive a portion of the coupon fee when the consumer purchased and used the coupon with the vendor. In this manner, the vendor was rewarded with minimal marketing costs, consumer business, and a portion of the coupon fee.

Coupon distribution and reward methods have been used for economically and efficiently marketing products and services in the past, yet none with the present characteristics of the present invention. See U.S. Pat. No. 5,708,782; U.S. Pat. No. 6,336,099; and U.S. Pat. No. 8,650,072.

For the foregoing reasons, there is a need for a system and method that rewards vendors for offering coupons by creating free distribution of coupons, and providing the vendor with a portion of a coupon fee.

### SUMMARY

The present invention describes a system and method that rewards vendors for offering nonpublished coupons. The system and method enables at least one vendor to market and distribute a unique coupon through a gateway. The vendor distributes the unique coupon for substantially free and is subsequently rewarded when a consumer performs a transaction involving the unique coupon. The unique coupon must have certain attributes for the vendor to qualify for the free distribution of unique coupon. For example, the unique coupon must be unique to each vendor and product or service. The unique coupon must also be time sensitive, among other possible attributes. Another novel feature of the system and method is that the unique coupon is sold to a consumer for a predetermined coupon fee, rather than given to the consumer gratuitously, as is normally the case.

Also, to access the coupon, the consumer must either search for the unique coupon from the vendor, a vendor website, or a gateway website. However, in other embodiments, the consumer may be automatically alerted about the unique coupon when the consumer enters a predetermined range of the vendor. The consumer may then purchase the unique coupon for a predetermined coupon fee, and utilize the coupon in a transaction with the vendor that is identified on the unique coupon. After the consumer uses the unique coupon, the vendor receives an additional benefit in that the vendor receives a portion of the coupon fee. Thus, the vendor is rewarded through multiple channels: free distribution of coupons, and thus an inexpensive way to distribute marketing material; a transaction from a consumer who was interested in the coupon and who may not have frequented the vendor otherwise; a differentiation from other vendors through the unique attributes of the coupon; and a portion of the coupon fee.

As discussed above, the vendor benefits by distributing the unique coupon through the gateway for substantially free, and subsequently being compensated when a consumer utilizes the coupon. However, the system and method has prerequisites before the vendor may participate. For one, the unique coupon must be unique, in that it is not regularly published for the public. For example, the unique coupon cannot be accessible in newspapers, mail outs, or company websites. Rather, the unique coupon must be unique to the system and method. Secondly, the unique coupon must be unique to the vendor. The unique coupon cannot be used for multiple vendors in a general category. Thirdly, the unique coupon must be time sensitive, such that the consumer has a limited time to use the unique coupon. In one example, the consumer has twenty four hours to use the unique coupon. This creates a sense of urgency for the consumer to visit the vendor and complete the transaction.

In some embodiments, once the vendor distributes the unique coupon through the gateway, the consumer may access the unique coupon in a variety of ways. One technique simply requires the vendor or the gateway to publish the unique coupon on a website. The consumer may then view the unique coupon while searching the internet for the vendor's or gateway's website. In some embodiments, the unique coupons may be accessed and purchased online through methods known in the art, including, without limitation, credit cards, PayPal™, money order, and telephone ordering. Another technique to inform the consumer about the unique coupon may involve the vendor or the gateway actively alerting the consumer that the unique coupon is available. In this embodiment, the vendor or gateway may transmit a text, phone call, or email to the consumer when the consumer is within a predetermined range of the vendor. This is an effective technique, as those skilled in the art are aware that the proximity of the consumer to the vendor provides an impetus for the consumer to purchase the unique coupon and frequent the vendor's business or organization. However, in other embodiments, any active notification to the consumer may be used to inform about the availability and price of the unique coupon.

In some embodiments, the vendor benefits in multiple ways when the consumer performs a transaction with the unique coupon. Obviously, the actual transaction is a benefit to the vendor. It is also significant to note that the consumer may not have entered into the transaction without the discounts offered by the unique coupon. Additionally, the unique coupon serves as a marketing material, as the vendor may mention the novelty of the unique coupon to other potential consumers. Finally, the vendor is rewarded by receiving a portion of the coupon fee paid by the consumer, which the consumer used to purchase the unique coupon in the first place. Thus, by receiving a portion of the coupon fee, part of the discount costs to the vendor are offset. All of the above mentioned rewards and benefits to the vendor may help the vendor compete for consumers with a small, or possibly no marketing budget.

One objective of the present invention is to enable at least one vendor to market and distribute a unique coupon for free.

Another objective is to enable at least one vendor to receive multiple types of rewards for distributing the unique coupon.

Another objective is to distribute coupons that are unique to the vendor, including coupons that are not published for the general public, and coupon that are restricted to products and services provided exclusively by the vendor.

Another objective is to distribute a unique coupon that is time sensitive, so that a sense of urgency is created with the consumer.

Another objective is to alert the consumer about the unique coupon when the consumer is proximal to the vendor or in a predetermined range.

Yet another objective is to generate revenue by charging the consumer a coupon fee for access to the unique coupon.

Yet another objective is to reward the vendor with a portion of the coupon fees.

### DRAWINGS

These and other features, aspects, and advantages of the present invention will become better understood with regard to the following description, appended claims, and drawings where:

FIG. 1 is a block diagram of an exemplary system that rewards vendors for offering nonpublished coupons;

FIG. 2 is a flowchart diagram of an exemplary method that rewards vendors for offering nonpublished coupons; and

FIG. 3 a block diagram depicting an exemplary client/server system which may be used by an exemplary web-enabled/networked embodiment of the present invention.

### DESCRIPTION

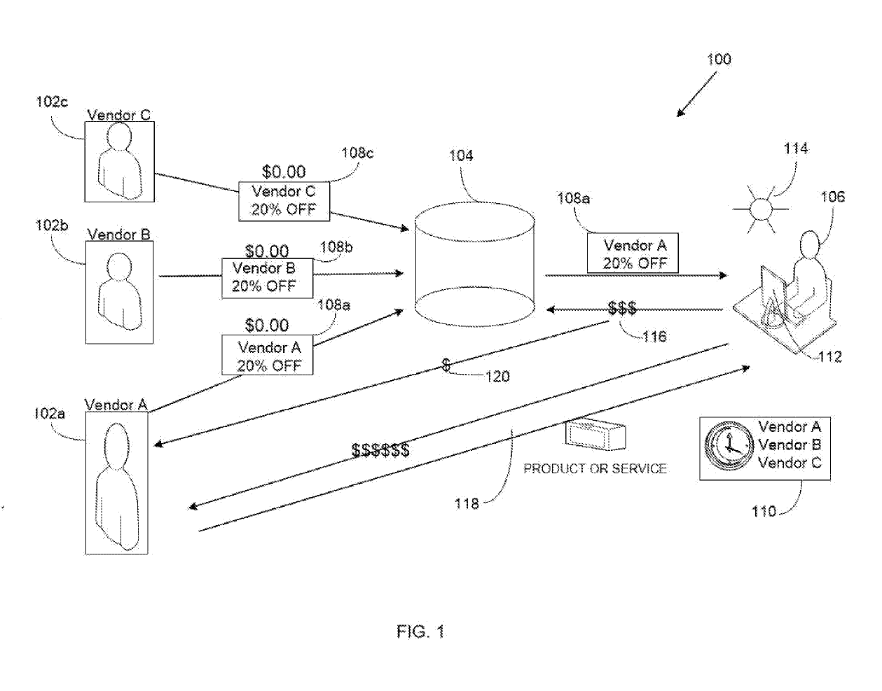

One embodiment, referenced in FIGS. 1-3, illustrates a system 100 and method 200 that rewards at least one vendor 102a, 102b, 102c for offering unique, nonpublished, time sensitive coupons 108a, 108b, 108c. In some embodiments, the system 100 may enable the at least one vendor 102a, 102b, 102c to distribute a unique coupon 108a, 108b, 108c through a gateway 104. The at least one vendor 102a may distribute the unique coupon 108a, 108b, 108c simultaneously with other vendors 102b, 102c, with each vendor 102a, 102b, 102c creating a customized offer on their unique coupon 108a, 108b, 108c. For example, multiple vendors 102a, 102b, 102c providing the same category of product may each create a unique coupon 108a, 108b, 108c, exclusively for use with their product and in their business venue to be used within a predetermined time frame. In one embodiment, the unique coupon 108a, 108b, 108c may include, without limitation, a marketing tool, such as a ticket or document that can be exchanged for a financial discount or rebate when purchasing a product or service. The unique coupon 108a, 108b, 108c may be accessed and exchanged for the discount in the form of a downloadable image, a QR code, a bar matrix code, a postcard, or a printout.

In one embodiment, the at least one vendor 102a, 102b, 102c distributes the unique coupon 108a, 108b, 108c for substantially free and is subsequently rewarded when a consumer 106 performs a transaction 118 involving the unique coupon 108a, 108b, 108c. In this manner, the vendor 102a, 102b, 102c can compete for consumers 106 while maintaining a small, or possibly no marketing budget. Those skilled in the art will recognize that the substantially free marketing offered by the system 100 can be useful when competing against larger, well-funded corporations and government entities.

However, the unique coupon 108a, 108b, 108c must have certain attributes 110 before the at least one vendor 102a, 102b, 102c can qualify for the free distribution of unique coupon 108a, 108b, 108c. For example, the unique coupon 108a, 108b, 108c must be unique to each vendor 102a, 102b, 102c and product or service. The unique coupon 108a, 108b, 108c must also be time sensitive, among other possible attributes 110. These features ensure that the vendor 102a, 102b, 102c receives the full benefits of the unique coupon 108a, 108b, 108c. Another novel feature of the system 100 is that the unique coupon 108a, 108b, 108c is sold to a consumer 106 for a predetermined coupon fee 116, rather than given to the consumer 106 gratuitously, as is normally the case. This enables the monetization of the system 100, and the subsequent rewarding of the vendor 102a, 102b, 102c for participating in the system 100.

Additionally, the consumer 106 must either search for the unique coupon 108a, 108b, 108c from the vendor 102a, 102b, 102c, a vendor website, or a gateway website to access the unique coupon 108a, 108b, 108c. However, in other embodiments, the consumer 106 may be contacted about the unique coupon 108a, 108b, 108c though an automated alert 114, such as text, email, or phone calls, when the consumer 106 enters a predetermined range of the at least one vendor 102a, 102b, 102c.

Once the consumer 106 has identified and examined the unique coupon 108a of interest, the consumer 106 may purchase the unique coupon 108a for a predetermined coupon fee 116, and utilize the coupon 108a in a transaction 118 with the vendor 102a that is identified on the unique coupon 108a. In essence, the consumer 106 receives a discount for purchasing the specified product or service with the specified vendor 102a on the unique coupon 108a. This forms one of the benefits that the vendor 102a receives, which is the business and awareness from the consumer 106.

After the consumer 106 exchanges the unique coupon 108a, 108b, 108c for the product or service, the vendor 102a, 102b, 102c receives an additional benefit in that the vendor 102a, 102b, 102c receives a reward 120 in the form of a portion of the coupon fee 116. Thus, the vendor 102a, 102b, 102c is rewarded through multiple channels: free distribution of the unique coupon 108a, 108b, 108cs, and thus an inexpensive way to distribute marketing material; a transaction 118 from a consumer 106 who was interested in the unique coupon 108a and who may not have frequented the vendor 102a otherwise; a differentiation from other vendors 102b, 102c through the unique attributes 110 of the coupon 108a; and a reward 120 in the form of a portion of the coupon fee 116.

As illustrated in FIG. 1, the at least one vendor 102a, 102b, 102c benefits by distributing the unique coupon 108a, 108b, 108c through the gateway 104 for substantially free, and subsequently being compensated when a consumer 106 utilizes the coupon 108a, 108b, 108c. However, the system 100 has prerequisites before the vendor 102a, 102b, 102c may participate. For one, the unique coupon 108a, 108b, 108c must be unique, in that it is not regularly published for the public. For example, the unique coupon 108a, 108b, 108c cannot be accessible in newspapers, mail outs, or company websites. Rather, the unique coupon 108a, 108b, 108c must be uniquely designed for used in the system 100. There should be no other manner in which to obtain the unique coupon 108a, 108b, 108c except through the gateway 104, and after the vendor 102a, 102b, 102c has distributed it through the gateway 104.

Secondly, the unique coupon 108a, 108b, 108c must be unique to the vendor 102a, 102b, 102c. The unique coupon 108a, 108b, 108c cannot be used for multiple vendors 102a, 102b, 102c in a general category. For example, two hardware store vendors may provide a coupon discount for hammers. But each hardware store has its own unique hammer coupon for the hammers.

Thirdly, the unique coupon 108a, 108b, 108c may be time sensitive, such that the consumer 106 has a limited time to use the unique coupon 108a, 108b, 108c. In one example, the consumer 106 has twenty four hours to use the unique coupon 108a, 108b, 108c. Beyond the twenty four time limit, the unique coupon 108a, 108b, 108c expires. The time sensitive requirement creates a sense of urgency for the consumer 106 to visit the vendor 102a, 102b, 102c and complete the transaction 118.

In some embodiments, once the vendor 102a, 102b, 102c distributes the unique coupon 108a, 108b, 108c through the gateway 104, the unique coupon 108a, 108b, 108c may be accessed by the consumer 106 in a variety of ways. One technique for making the unique coupon 108a, 108b, 108c easily accessible to the consumer 106 simply requires the vendor 102a, 102b, 102c or the gateway 104 to publish the unique coupon 108a, 108b, 108c on a website. The consumer 106 may then view the unique coupon 108a, 108b, 108c while searching the internet for the vendor website or the gateway website. In some embodiments, the unique coupon 108a, 108b, 108c may be accessed and purchased online through payment methods known in the art, including, without limitation, credit cards, PayPal™, money order, and telephone ordering.

Another technique to inform the consumer 106 about the unique coupon 108a, 108b, 108c may involve the vendor 102a, 102b, 102c or the gateway 104 actively contacting the consumer 106 through an alert 114 that the unique coupon 108a, 108b, 108c is available. In this embodiment, the vendor 102a, 102b, 102c or gateway 104 may transmit a text, phone call, or email to the consumer 106 when the consumer 106 is within a predetermined range of the vendor 102a, 102b, 102c. This is an effective technique, as those skilled in the art are aware that the proximity of the consumer 106 to the vendor 102a, 102b, 102c provides an impetus for the consumer 106 to purchase the unique coupon 108a, 108b, 108c and frequent the vendor's 102a, 102b, 102c business or organization. However, in other embodiments, any active notification to the consumer 106 may be used to inform about the availability and price of the unique coupon 108a, 108b, 108c.

For example, as a consumer 106 approaches a coffee shop in a mall, the consumer 106 receives a text indicating that a coffee coupon for the coffee shop is available. The unique coupon 108a may provide 20% off the price of a large coffee if the coffee coupon is purchased and used in the next hour. The consumer 106, having received the text, may then purchase the coffee coupon through a smart phone using standard online purchasing techniques known in the art. However, in one alternative embodiment, the consumer 106 may purchase the coffee coupon directly from the counter of the coffee shop. Nonetheless, in either case, the coffee coupon possesses the attributes 110 of being exclusively for the coffee shop and having a time limit to be used.

In some embodiments, once the consumer 106 is made aware of the unique coupon 108a, 108b, 108c the consumer 106 may purchase the unique coupon 108a, 108b, 108c for a coupon fee 116, which is generally less than the benefit provided by the coupon 108a, 108b, 108c. For example, the coupon 108a, 108b, 108c may be purchased for one dollar, while the discount offered by the unique coupon 108a, 108b, 108c is five dollars. The gateway 104 provides multiple ways for the consumer 106 to purchase the unique coupon 108a, 108b, 108c. In one embodiment, the consumer 106 may purchase directly online from the website of the gateway 104 or the vendor 102a, 102b, 102c. The consumer 106 may also purchase the unique coupon 108a, 108b, 108c directly from the vendor 102a, 102b, 102c. In yet another embodiment, the consumer 106 may purchase the unique coupon 108a, 108b, 108c from a coupon distribution server.

For example, the consumer 106 may connect to the coupon distribution server using a connection program such as a web browser installed in the consumer's 106 information dispersion system 112, i.e., personal computer terminal, and may log in to the coupon distribution server by inputting an ID and a password on an initial log-in window. After logging in, the consumer 106 may view and select the desired unique coupon 108a, 108b, 108c by inputting coupon-related information on a specific screen window provided by the coupon distribution server.

It is significant to note that the vendor 102a, 102b, 102c benefits in multiple ways when the consumer 106 performs a transaction 118 with the unique coupon 108a, 108b, 108c. Obviously, the actual transaction 118 is a benefit to the vendor 102a, 102b, 102c. It is also significant to note that the consumer 106 may not have entered into the transaction 118 without the discounts offered by the unique coupon 108a, 108b, 108c. Thus the system 100 enables the consumer 106 to be made aware of the vendor 102a, 102b, 102c, when the consumer 106 may not have known about the vendor 102a, 102b, 102c initially. Additionally, the unique coupon 108a, 108b, 108c serves as a marketing material, as the consumer 106 may mention the novelty of the unique coupon 108a, 108b, 108c to other potential consumers 106 in person or through a social media site.

Finally, the vendor 102a, 102b, 102c is rewarded by receiving a reward 120 in the form of a portion of the coupon fee 116 paid by the consumer 106. As discussed above, the consumer 106 paid the coupon fee 116 to purchase the unique coupon 108a, 108b, 108c in the first place. Thus, by receiving a portion of the coupon fee 116, part of the discount costs offered by the vendor 102a, 102b, 102c are offset.

In one example, the consumer 106 purchases the unique coupon 108a from the gateway 104 for a coupon fee 116 of one dollar. The consumer 106 uses the unique coupon 108a with the vendor 102a to receive 20% off a product or service. The gateway 104 give the vendor 102a a reward 120 of five cents from the dollar coupon fee 116, and retains the ninety-five cents balance as payment for promoting the unique coupon 108a and providing access to the unique coupon 108a too the consumers 106. In essence, all of the above mentioned rewards 120 and benefits to the vendor 102a, 102b, 102c help the vendor 102a, 102b, 102c compete for consumers 106 with a small, or possibly no marketing budget.

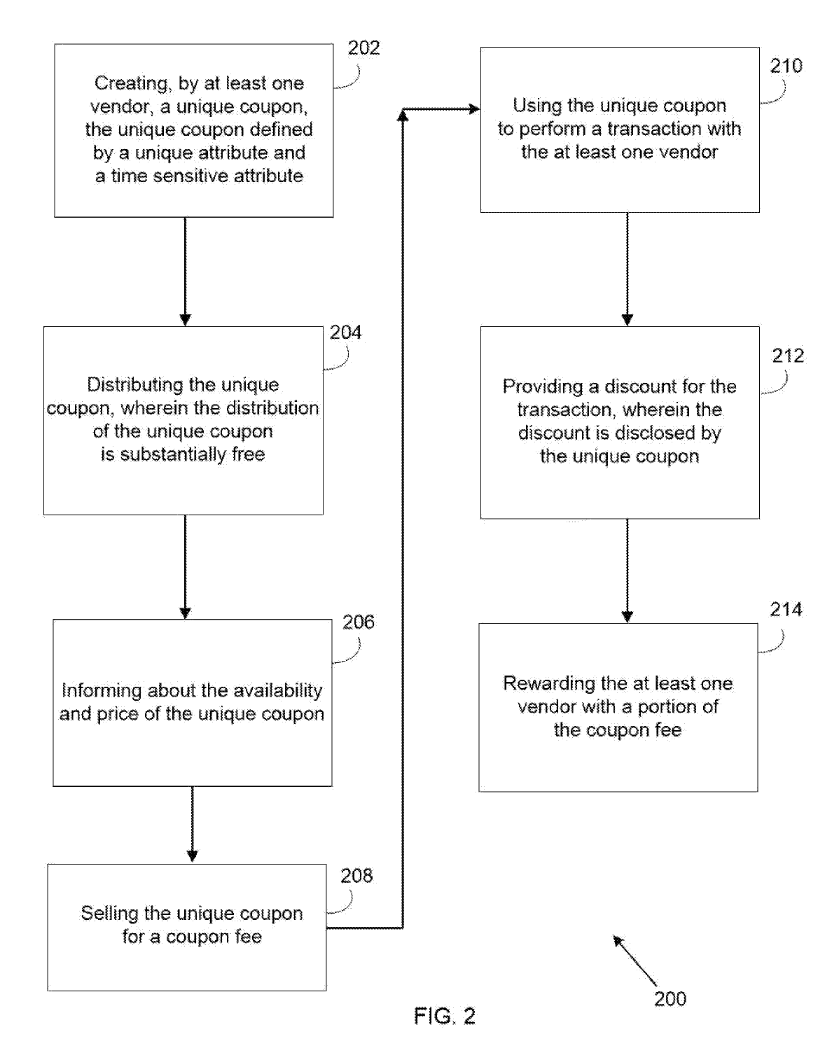

FIG. 2 illustrates a flowchart diagram of an exemplary method 200 that rewards at least one vendor 102a, 102b, 102c for offering unique coupons 108a, 108b, 108c. The method 200 enables the vendor 102a, 102b, 102c to market and distribute the unique coupon 108a, 108b, 108c through a gateway 104, which may include a website, server, cloud, or internet company. The vendor 102a, 102b, 102c distributes the unique coupon 108a, 108b, 108c for substantially free through the gateway and is subsequently rewarded when a consumer 106 performs a transaction 118 with the unique coupon 108a, 108b, 108c. The gateway 104 promotes and distributes the unique coupon 108a, 108b, 108c. The unique coupon 108a, 108b, 108c comprises attributes 110 of being unique and time specific. These attributes 110 help the vendor 102a, 102b, 102c control the subsequent transaction 118. Chiefly, the unique coupon 108a, 108b, 108c may be used only for the vendor 102a, 102b, 102c who created it. The unique coupon 108a, 108b, 108c may also be used in a predetermined time frame. The consumer 106 must access and purchase the coupon 108a, 108b, 108c for a coupon fee 116 to receive the benefits thereof. The vendor 102a, 102b, 102c receives a portion of the coupon fee 116 as a reward 120. The method 200 may generally be applied to any business or organizational transactions 118 where marketing and coupon enabled discounts are practiced. The method 200 may reside in an apparatus and software and be effective for enabling the vendor 102a, 102b, 102c to select, print, and dispense the unique coupon 108a, 108b, 108c and receive a reward 120 thereafter.

The method 200 may include an initial Step 202 of creating, by at least one vendor 102a, 102b, 102c, a unique coupon 108a, 108b, 108c, the unique coupon 108a, 108b, 108c defined by a unique attribute 110 and a time sensitive attribute 110. The at least one vendor 102a, 102b, 102c decides on the discount to be offered and designs an appropriate unique coupon 108a, 108b, 108c. The unique coupon 108a, 108b, 108c may include, without limitation, a marketing tool, such as a ticket or document that can be exchanged for a financial discount or rebate when purchasing a product or service. The unique coupon 108a, 108b, 108c may be accessed and exchanged for the discount in the form of a downloadable image, a QR code, a bar matrix code, a postcard, or a printout.

The method 200 may further comprise a Step 204 of distributing the unique coupon 108a, 108b, 108c, wherein the distribution of the unique coupon 108a, 108b, 108c is substantially free. The at least one vendor 102a, 102b, 102c distributes the unique coupon 108a, 108b, 108c for substantially free and is subsequently rewarded when a consumer 106 performs a transaction 118 involving the unique coupon 108a, 108b, 108c. In this manner, the vendor 102a, 102b, 102c can compete for consumers 106 while having only a small, or possibly no marketing budget. However, the method 200 has prerequisites before the vendor 102a, 102b, 102c may distribute the unique coupon 108a, 108b, 108c. For one, the unique coupon 108a, 108b, 108c must be unique, in that it is not regularly published for the public and is exclusive for the vendor 102a, 102b, 102c. Also, the unique coupon 108a, 108b, 108c is time sensitive, such that it must be used in a predetermined time frame.

A Step 206 includes informing about the availability and price of the unique coupon 108a, 108b, 108c. The gateway 104 promotes the unique coupon 108a, 108b, 108c and informs through websites, alerts 114, and advertising about the presence of the unique coupon 108a, 108b, 108c. In some embodiments, the method 200 comprises a Step 208 of selling the unique coupon 108a, 108b, 108c for a coupon fee 116. The consumer 106 may purchase the unique coupon 108a, 108b, 108c for a coupon fee 116, which is generally less than the benefit provided by the coupon 108a, 108b, 108c. This creates incentive for the consumer 106 to purchase the unique coupon 108a, 108b, 108c. The gateway 104 provides multiple ways for the consumer 106 to purchase the unique coupon 108a, 108b, 108c. In one embodiment, the consumer 106 may purchase the unique coupon 108a, 108b, 108c directly online from the website of the gateway 104 or the vendor 102a, 102b, 102c. The consumer 106 may also purchase the unique coupon 108a, 108b, 108c directly from the vendor 102a, 102b, 102c.

A Step 210 includes using the unique coupon 108a, 108b, 108c to perform a transaction 118 with the at least one vendor 102a, 102b, 102c. The transaction 118 is performed exclusively with the vendor 102a, 102b, 102c that provided the unique coupon 108a, 108b, 108c. In some embodiments, a Step 212 may include providing a discount for the transaction 118, wherein the discount is disclosed by the unique coupon 108a, 108b, 108c. The consumer 106 uses the unique coupon 108a, 108b, 108c to receive an exclusive discount for a product or service from a single vendor 102a. A final Step 214 includes rewarding the at least one vendor 102a, 102b, 102c with a portion of the coupon fee 116. The vendor 102a, 102b, 102c is rewarded by receiving a portion of the coupon fee 116 paid by the consumer 106, which the consumer 106 used to purchase the unique coupon 108a, 108b, 108c in the first place. Thus, by receiving a portion of the coupon fee 116, part of the discount costs offered by the vendor 102a, 102b, 102c in the unique coupon 108a, 108b, 108c are offset. In essence, all of the above mentioned rewards 120 and benefits to the vendor 102a, 102b, 102c help the vendor 102a, 102b, 102c compete for consumers 106 while maintaining a small marketing budget.

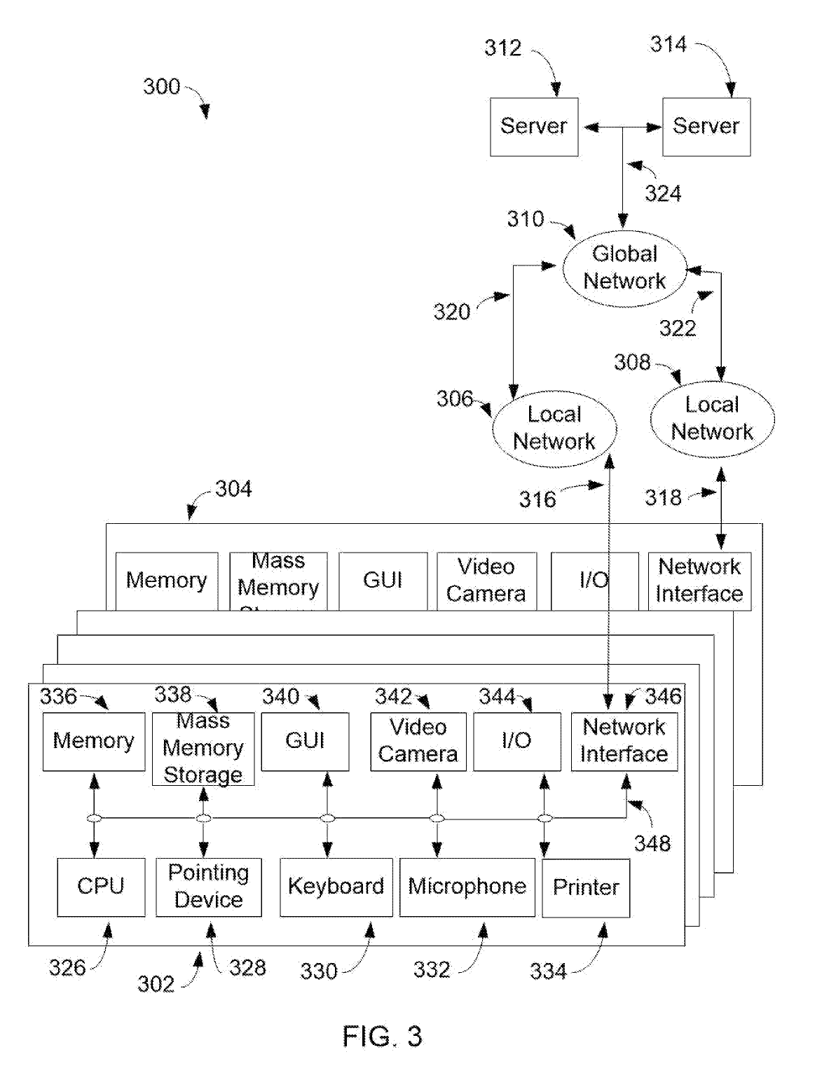

FIG. 3 is a block diagram depicting an exemplary client/server system which may be used by an exemplary web-enabled/networked embodiment of the present invention.

A communication system 300 includes a multiplicity of clients with a sampling of clients denoted as a client 302 and a client 304, a multiplicity of local networks with a sampling of networks denoted as a local network 306 and a local network 308, a global network 310 and a multiplicity of servers with a sampling of servers denoted as a server 312 and a server 314.

Client 302 may communicate bi-directionally with local network 306 via a communication channel 316. Client 304 may communicate bi-directionally with local network 308 via a communication channel 318. Local network 306 may communicate bi-directionally with global network 310 via a communication channel 320. Local network 308 may communicate bi-directionally with global network 310 via a communication channel 322. Global network 310 may communicate bi-directionally with server 312 and server 314 via a communication channel 324. Server 312 and server 314 may communicate bi-directionally with each other via communication channel 324. Furthermore, clients 302, 304, local networks 306, 308, global network 310 and servers 312, 314 may each communicate bi-directionally with each other.

In one embodiment, global network 310 may operate as the Internet. It will be understood by those skilled in the art that communication system 300 may take many different forms. Non-limiting examples of forms for communication system 300 include local area networks (LANs), wide area networks (WANs), wired telephone networks, wireless networks, or any other network supporting data communication between respective entities.

Clients 302 and 304 may take many different forms. Non-limiting examples of clients 302 and 304 include personal computers, personal digital assistants (PDAs), cellular phones and smartphones.

Client 302 includes a CPU 326, a pointing device 328, a keyboard 330, a microphone 332, a printer 334, a memory 336, a mass memory storage 338, a GUI 340, a video camera 342, an input/output interface 344 and a network interface 346.

CPU 326, pointing device 328, keyboard 330, microphone 332, printer 334, memory 336, mass memory storage 338, GUI 340, video camera 342, input/output interface 344 and network interface 346 may communicate in a unidirectional manner or a bi-directional manner with each other via a communication channel 348. Communication channel 348 may be configured as a single communication channel or a multiplicity of communication channels.

CPU 326 may be comprised of a single processor or multiple processors. CPU 326 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 336 is used typically to transfer data and instructions to CPU 326 in a bi-directional manner. Memory 336, as discussed previously, may include any suitable computer-readable media, intended for data storage, such as those described above excluding any wired or wireless transmissions unless specifically noted. Mass memory storage 338 may also be coupled bi-directionally to CPU 326 and provides additional data storage capacity and may include any of the computer-readable media described above. Mass memory storage 338 may be used to store programs, data and the like and is typically a secondary storage medium such as a hard disk. It will be appreciated that the information retained within mass memory storage 338, may, in appropriate cases, be incorporated in standard fashion as part of memory 336 as virtual memory.

CPU 326 may be coupled to GUI 340. GUI 340 enables a user to view the operation of computer operating system and software. CPU 326 may be coupled to pointing device 328. Non-limiting examples of pointing device 328 include computer mouse, trackball and touchpad. Pointing device 328 enables a user with the capability to maneuver a computer cursor about the viewing area of GUI 340 and select areas or features in the viewing area of GUI 340. CPU 326 may be coupled to keyboard 330. Keyboard 330 enables a user with the capability to input alphanumeric textual information to CPU 326. CPU 326 may be coupled to microphone 332. Microphone 332 enables audio produced by a user to be recorded, processed and communicated by CPU 326. CPU 326 may be connected to printer 334. Printer 334 enables a user with the capability to print information to a sheet of paper. CPU 326 may be connected to video camera 342. Video camera 342 enables video produced or captured by user to be recorded, processed and communicated by CPU 326.

CPU 326 may also be coupled to input/output interface 344 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 326 optionally may be coupled to network interface 346 which enables communication with an external device such as a database or a computer or telecommunications or internet network using an external connection shown generally as communication channel 316, which may be implemented as a hardwired or wireless communications link using suitable conventional technologies. With such a connection, CPU 326 might receive information from the network, or might output information to a network in the course of performing the method steps described in the teachings of the present invention.

While the inventor's above description contains many specificities, these should not be construed as limitations on the scope, but rather as an exemplification of several preferred embodiments thereof. Many other variations are possible. Accordingly, the scope should be determined not by the embodiments illustrated, but by the appended claims and their legal equivalents.

What is claimed is:

1. A method for rewarding a vendor for offering unique coupons, the method comprising:
creating, by at least one vendor, a unique coupon, the unique coupon defined by a unique attribute and a time sensitive attribute;
distributing the unique coupon, wherein the distribution of the unique coupon is substantially free;
informing about the availability and price of the unique coupon;
selling the unique coupon for a coupon fee;
using the unique coupon to perform a transaction with the at least one vendor;
providing a discount for the transaction, wherein the discount is disclosed by the unique coupon; and
rewarding the at least one vendor with a portion of the coupon fee.

2. The method of claim 1, wherein the at least one vendor comprises a plurality of businesses or organizations.

3. The method of claim 2, wherein each business or organization creates separate unique coupons.

4. The method of claim 1, wherein the unique coupon comprises a discount for a product or service that is accessible as a downloadable image, a QR code, a bar matrix code, or a printout.

5. The method of claim 1, wherein the unique attribute for the unique coupon comprises a coupon that is not published for the general public.

6. The method of claim 1, wherein the unique attribute for the unique coupon comprises a coupon that is specific to only a product or service provided by the at least one vendor.

7. The method of claim 1, wherein the time sensitive attribute for the unique coupon comprises coupons that must be used in a predetermined time limit.

8. The method of claim 1, wherein the step of distributing the unique coupon further comprises the at least one vendor uploading the unique coupon to a gateway website or server.

9. The method of claim 1, wherein the step of informing about the availability and price of the unique coupon comprises sending a text alert to a consumer when the consumer is in a predetermined range to the at least one vendor.

10. The method of claim 9, wherein the step of informing about the availability and price of the unique coupon comprises the consumer searching the internet for the at least one vendor or a gateway coupon provider.

11. The method of claim 10, wherein the step of informing about the availability and price of the unique coupon comprises the consumer searching the internet for a product or service provided by the at least one vendor.

12. The method of claim 11, wherein the step of selling the unique coupon comprises the consumer purchasing the unique coupon.

13. The method of claim 1, wherein the coupon fee is less than the discount offered by the unique coupon.

14. A method for rewarding a vendor for offering unique coupons, the method comprising:
creating, by at least one vendor, a unique coupon, the unique coupon defined by a unique attribute, the unique attribute comprising a coupons that is not published for the general public, the unique coupon further comprising a time sensitive attribute, the time sensitive attribute comprising a coupon that must be used in a predetermined time limit;
distributing the unique coupon, wherein the distribution of the unique coupon is substantially free;
informing about the availability and price of the unique coupon, wherein the information about the unique coupon is from a website;
selling the unique coupon for a coupon fee;
using the unique coupon to perform a transaction with the at least one vendor;
providing a discount for the transaction, wherein the discount is disclosed by the unique coupon; and
rewarding the at least one vendor with a portion of the coupon fee, wherein the portion of the coupon fee is less than the discount offered by the unique coupon.

15. A system for rewarding a vendor for offering unique coupons, the system comprising:
a unique coupon defined by a unique attribute and a time sensitive attribute, the unique coupon configured to be distributed by at least one vendor for substantially free;
a gateway distribution configured to distribute the unique coupon;
an information dispersion system configured to inform a consumer about the availability and price of the unique coupon;
an alert configured to alert the consumer about the unique coupon when the consumer is in a predetermined range to the at least one vendor;
a coupon fee configured to be paid by the consumer;
a transaction configured to be performed through the use of the unique coupon in accordance with the unique attribute and the time sensitive attribute;
a reward comprising at least a portion of the coupon fee, the reward configured to be provided to the at least one vendor.

16. The system of claim 15, wherein the unique coupon comprises a discount for a product or service that is accessible as a downloadable image, a QR code, a bar matrix code, or a printout.

17. The system of claim 1, wherein the unique attribute for the unique coupon comprises a coupon that is not published for the general public or a coupon that is specific to only a product or service provided by the at least one vendor.

18. The system of claim 1, wherein the time sensitive attribute comprises a coupon that must be used in a predetermined time limit.

19. The system of claim 1, wherein the alert comprises a text alert to the consumer when the consumer is in a predetermined range to the at least one vendor.

20. The system of claim 1, wherein the information dispersion system comprises an internet website configured to inform about the availability and price of the unique coupon.
